(19) United States
(12) Patent Application Publication
(10) Pub. No.: US 2002/0150704 A1
(43) Pub. Date: Oct. 17, 2002

(54) Economical oxygen barrier structures utilizing EVOH/polyolefin blends

(76) Inventors: Eric Baer, Cleveland Heights, OH (US); P. Anne Hiltner, Cleveland, OH (US); Charles Eugene Gibbons, Mobile, AL (US); Gregory James Castle, Wilder, KY (US); Andrew Patrick Sullivan, Maineville, OH (US); Irving Daniel Sand, Loveland, OH (US)

Correspondence Address: Hoffman, Wasson & Gitler, P.C., Suite 522, 2361 Jefferson Davis Highway, Arlington, VA, 22202, US

(21) Appl. No.: 10/058,040

(22) Filed: Jan. 29, 2002

Related U.S. Application Data
(60) Provisional application No. 60/265,124, filed on Jan. 31, 2001.

(51) Int. Cl. B32B 1/08; B32B 23/08

(52) U.S. Cl. 428/34.2; 428/34.3; 428/512; 428/513; 428/514

(57) ABSTRACT

A laminate structure for both packaging and non-packaging applications, including a five layer coextrusion composite containing an EVOH/polyolefin composite barrier layer coated or applied to a paper or paperboard substrate. The laminated structure may contain a layer of linear low density polyethylene or other layers, as needed for the application. The EVOH/polyolefin blend layer is preferably a blend of an ethylene vinyl alcohol copolymer having 44% ethylene moiety and a low density polyethylene polymer. The blend barrier, which is part of a five layer coextrusion composite layer provides improved oxygen and moisture barrier characteristics to a package, prepared from such a laminated structure, as well as improved rigidity and heat resistance, thereby providing longer shelf life and excellent flavor retention to the stored contents as well as improved dimensional stability to the cartons, package or containers, at a reduced cost.

### BACKGROUND OF THE INVENTION

The invention relates to laminate structures for packaging and non-packaging applications. This laminated structure can be used for both food and non-food packaging applications. More particularly, there is provided a laminate structure including a paper or paperboard substrate having at least one layer of a EVOH/polyolefin composite containing an ethylene vinyl alcohol copolymer (44 mole % ethylene) and a polyolefin polymer resin. This EVOH/polyolefin composite layer is produced in the absence of a compatibilizer and can be directly attached to or coated on a paper or paperboard with a linear low density polyethylene tying layer. When the EVOH/polyolefin composite layer is produced in the absence of compatibilizers, interfacial regions result between the two phases with void areas. These void areas are large enough to allow small molecules such as oxygen or water to fill them.

The phrase “EVOH/polyolefin composite” refers to a blend of ethylene vinyl alcohol copolymer and a polyolefin. The EVOH/polyolefin composite includes any variety EVOH or polyolefin in the preferred range of 35-95% EVOH. The materials can be melt or dry blended and are extrusion coated onto the paperboard or paper substrate without compatibilization. The composite creates a structure with discrete polyolefin domains dispersed in a continuous EVOH matrix. The resulting barrier structure has an oxygen transmission rate (OTR) at 75% relative humidity (RH) that is 0.75 times the OTR at 0% RH. The composite blends can be incorporated into structures used for packages containing milk, cereal, orange juice, or the like.

U.S. Pat. No. 3,975,463 mentions formulations that do not include a compatiblizer. The formulations are described, in the examples, solely for the sake of comparison of OTR and other material properties with compatibilized systems. The examples show that the addition of compatibilizer slightly lowers oxygen barrier performance, but improves appearance and increases mechanical performance. The patent addresses using these barriers in containers, films or tubes. No mention is made of a multilayer coextrusion. The patent was aimed at combining EVOH and LDPE in a single layer with a compatibilizer to eliminate the need for multilayer structures while providing a combined water and oxygen barrier.

U.S. Pat. No. 3,931,449 claims a laminate structure comprising an EVOH/polyolefin blend layer in a large variety of multilayer structures. The blend layer is claimed with and without a compatibilizer. The blend is claimed to consist of alternating layers of EVOH rich and polyolefin rich material, providing the structure with improved oxygen barrier relative to the arithmetic mean of the two individual components. The teachings state that a low degree of mixing is used to create this morphology. A higher degree of mixing would produce a homogenous structure, which would have oxygen barrier properties equal to the weighted average of the two components. Example #3 of the patent conflicts with this teaching, however. The example states that a homogenous mixture was used for the blend in a previous example which yielded oxygen permeability data very close to that of a laminar blend structure. The patent makes no mention of improved oxygen barrier performance at high relative humidities. Example 15 and 16 show data for oxygen permeability at 15% and 75% relative humidity in order to show the benefits of using the blend layer to protect a separate EVOH layer from atmospheric moisture. The examples indicate a smaller decrease in performance of the structure with the protected EVOH layer versus the unprotected structure, however this is different than the benefit at high relative humidity found with the present invention. For both examples 15 and 16, the blend layers are coextruded in a two layer structure with a metering screw. The present invention is different in that it shows increased performance at high relative humidity in well mixed blends unlike U.S. Pat. No. 3,931,449. The mixing history of the blend does not significantly impact barrier performance. It is the induced orientation of the polyolefin domains in the melt curtain, specifically associated with the extrusion coating process, which is the dominant factor.

U.S. Pat. No. 5,356,990 claims a continuous EVOH phase with the use of compatibilizers in the discontinuous LDPE phase. The teachings describe how the blend morphology can be controlled with the order of mixing EVOH and LDPE pellets. The patent teaches a continuous EVOH structure can be formed with as little as 35% EVOH if LDPE is added to a premelt of EVOH. They claim the simultaneous addition of the two resins will produced a LDPE continuous phase if the EVOH composition is less than 50-55%. Our results have shown a continuous EVOH structure with as little as 35% EVOH even with simultaneous addition of the resins. From these different results, it seems likely that the addition of compatibilizer has a substantial effect on morphological development. It is possible that the lack of compatibilizer in the blend results in high enough interfacial energies that as the polyolefin melts, the interaction with EVOH is so minimal that the system behaves as if the EVOH is not present.

European patent No. 0423511 claims a polyethylene/EVOH blend as the product contacted layer of a package of the purposes of a flavor barrier. The structure is PE/board/PE/blend. No data is given for the oxygen transmission properties of the board. An additional structure is present in which a second blend layer is utilized as a supplementary oxygen barrier if needed. The structure is PE/board/PE/blend/PE/blend. No mention is made of the type of PE used. The composition of the barrier layers were given as up to 80% PE (50-80%, preferably 40%).

Many foods, especially liquids, are susceptible to oxygen or other gases that cause them to spoil, degrade, or change flavor. Therefore, the package or container that is used to store the food should have very good oxygen barrier properties to protect its contents.

It is also very important that the package have very good moisture barrier, so that moisture does not penetrate if dry food is stored inside. In the case for liquid (or water-containing) storage, the excellent moisture barrier properties of the package will minimize the moisture transport out of the package, as well. This can be enhanced by applying polyolefin layers to the laminate structure.

The cellulosic materials in the cartons themselves are susceptible to moisture which weakens their internal bonds and leads to bulging of the carton and a perception of a spoiled and obsolete product on the shelf. The weakening of the internal fibrous structure inside a paperboard can happen through any one or any combination of the following three mechanisms: 1) diffusion of moisture through the polymer resin coating on the cartons into the paper, 2) moisture wicking through pinholes or defects generated by coating and the subsequent converting processes, and 3) moisture wicking through unprotected raw edge at the side seam or at the bottom seam. If the resin layer can impart sufficient stiffness to the whole carton structure, it is possible to maintain the carton integrity even though the internal fibrous structure inside the paperboard is weakened.

In the second mechanism, the defects are often caused by blister or bubble formation on the layer immediately adjacent to the paperboard at the inside of the carton. This happens during heat sealing when intensive heat is applied to the inside of the carton. Since paperboard usually contains some amount of moisture, in equilibrium with the outside environment, this intensive heat can vaporize the moisture inside the paperboard. The outside carton surface is usually coated with a layer of a moisture barrier such as polyethylene. The temperature at the outside surface is not very high. Hence this outside moisture barrier layer remains rather rigid. Therefore, the vapor cannot escape through the outside barrier layer. Since the inside surface temperature is very high, the polymer layer immediately adjacent to the paperboard may be “softened” enough so that blister formation becomes inevitable. Therefore, a polymer with good heat resistance adjacent to the paperboard is important to prevent this blister formation from happening.

Polyolefins such as polyethylene or polypropylene have been used to provide the moisture barrier properties needed. Generally speaking, a resin exhibiting excellent moisture barrier does not have good oxygen barrier and vice versa. As a result, multi-layer structures containing both oxygen barrier layers and moisture barrier layers are produced to address these concerns.

Ethylene vinyl alcohol copolymer (EVOH) has excellent oxygen barrier properties and has been used in packaging applications, such as orange juice packaging. However, the oxygen barrier of EVOH is known to be sensitive to moisture content in the environment and relative humidity (RH). At high relative humidity, EVOH tends to lose its oxygen barrier properties. This is not desirable. The processing of EVOH is known to be sensitive to processing temperatures, moisture level inside the resin, and equipment design. If these concerns are not addressed, gel formation tends to occur in the EVOH extrusion coating process, adversely impacting long term production.

Typically, linear low density polyethylene (LLDPE) does not possess the low oxygen transmission rates necessary for producing packaging containers economically. Hence the package requires a very thick LLDPE layer if LLDPE alone is to be used for such applications. It is not economically feasible to make such a thick layer of LLDPE in a laminated structure. However if one could significantly reduce the oxygen transmission rates of LLDPE such as by using EVOH/polyolefin composite barrier layers in a coextrusion onto the LLDPE layer. The multilayer laminate structures containing paper or paperboard and such LLDPE with the five layer EVOH/polyolefin composite coextrusion:

Low density polyethylene (LDPE) tie layer

EVOH/polyolefin

tie layer

Low density polyethylene (LDPE)

could be used for the packaging applications listed above.

This invention covers the use of such five layer coextrusions in combination with LLDPE in such multi-layer resin/paper laminate structures.

The conventional method of making a paper/multilayer polymer laminate structure containing a least a layer of EVOH/polyolefin composite is to use the compatibilizers in the blend and coat same onto a moving paper web in a single polymer melt through the extrusion coating die. The paper/polymer melt laminate is then subsequently passed through a nip roll/chill roll in order for it to cool down before it is wound up in the winding station. Sometimes one has to apply treatment on the paper surface in order for it to stick to the hot polymer melt. The usual treatment is flame treatment so that polar species are induced on the paper surface. The flame treatment is usually done on-line. Other suitable surface treatments include corona discharge, ozone treatment, etc. These treatments can be done on-line or off-line. In the case of multi-layer coating, various polymer melts from different extruders flow through the heated pipes to a feed block. Each polymer melt is converted into a layered form inside the feed block. Various molten polymer layers are then combined at the exit of the feed block before it enters into the extrusion coating die. An alternative method is to use the multiple manifold die and let the layers combine inside the die. The layers are combined at or close to the final land of the die, and they exit as one integral layer. A third approach combines both the feed block and multiple manifolds to provide even better processing control.

Another method of making a paper/multilayer polymer laminate structure containing the five layer coextrusion is to use an extrusion lamination process. In this process, a solid polymer laminate that has been pre-formed elsewhere is fed along with the moving paper web through an extrusion die. A polymer hot melt layer (as an adhesive layer) is directed through the extrusion die and deposited between the paper web and the laminate. The paper/adhesive/laminate is then passed through the nip roll and the chill roll to cool down before it is wound on the roll at the winding station. Sometimes it is necessary to apply a surface treatment on the laminate film surface in order for it to stick to the adhesive layer. It is also necessary to apply a surface treatment on the paper for the same reason. The surface treatment for the laminate film can be corona discharge or ozone treatment and can be done either on-line or off-line. As for the surface treatment for paper, it can be flame, corona discharge, or ozone. An alternative method is to use adhesive lamination, where an adhesive, a primer or a glue is applied between two adjacent layers or substrates during the lamination process.

With the above methods and alternative ones that are known to one skilled in the art, one can prepare the laminated structures of this invention. The five layer coextrusion EVOH/polyolefin composite is applied to the layer of LLDPE which has been applied to the surface of the paper or paperboard substrate in a relatively thin, continuous layer, preferably without any pinholes. The five layer composite layer is preferably applied with coating weights as follows:

LDPE 4.5 lbs.

tie layer 1.5 lbs.

EVOH/polyolefin 3-5 lbs.

tie layer 1.5 lbs.

LDPE 4.5 lbs.

The weight are given in pounds per three thousand square feet.

Examples of the paper or paperboard would include but are not restricted to bleached paperboard, unbleached paperboard, kraft, sulfide, multi-ply, etc. The weight of the paper or paperboard could vary from 3 lbs./3,000 SF to 500 lbs./3,000 SF. A particularly preferred substrate is a bleached paperboard made by International Paper Company with weights in the range of 150 lb. to 350 lbs./3,000 SF and more preferably in the range of 180 to 291 lbs./3,000 SF.

Various coatings or treatments may be applied to the paperboard before or after co-extrusion coating process. These coatings could include sizing agents, primers and other wet-end and off-line additives.

It is an object of this invention to produce a package or container that has improved physical barrier properties in its laminate structure using the laminate structure of the invention.

Additionally, it is an objective of the present invention to produce a food package that has the ability to contain reduced thickness of the barrier layers in the laminate structure, thereby reducing the overall cost of the structure.

It is a further object of the invention to produce laminated structures for various applications including for conversion to a package for food and non-food applications that provides improved flavor retention, oxygen and moisture barrier properties and heat resistance.

### SUMMARY OF THE INVENTION

According to the present invention, there is disclosed a preferred five layer coextrusion structure containing a center barrier layer of an EVOH/polyolefin composite layer and a LLDPE polymer resin layer that serves as a coating for the matte side of the substrate and as the contact for the five layer coextrusion. The package is suitable for the containment of liquids such as milk, juice, liquid detergent, or liquid fabric softener and for storage of dry food such as cocoa powders. The package is especially suitable for packaging oxygen-sensitive foods, especially liquids, such as citrus juices or blends thereof.

A preferred EVOH/polyolefin composite combines an ethylene vinyl alcohol copolymer material which has an ethylene content ranging from 29-50%, preferably 44% ethylene and a polyolefin polymer such as low density polyethylene, linear low density polyethylene, or polypropylene, as the barrier layer which is the center of the five layer coextrusion. When the five layer coextrusion with the EVOH/polyolefin composite layer composite layer is placed adjacent to the linear low density polyethylene polymer layer coated on the inner surface of the board one or more layers of low density polyethylene polymer can be used to enhance adhesion between the two layers (the composite and the LLDPE).

The following structures are alternate preferred structures examples of preferred laminates embodying the present invention. In all the examples the blend layer is 50% EVOH and 50% low density polyethylene, with the EVOH have 44% ethylene content.

### Structure 1

Layer#

1. Low density polyethylene (gloss layer) 12 lbs.

2. Paperboard (substrate) 205 lbs.

3. Linear low density polyethylene 5 lbs.

4. Low density polyethylene 2 lbs.

5. Low density polyethylene 6 lbs.

6. Low density polyethylene 4.5 lbs.

7. Tie layer 1.5 lbs.

8. EVOH/LDPE 3 lbs.

9. Tie layer 1.5 lbs.

10. Low density polyethylene (matte layer) 4.5 lbs.

Layers 6-10 are a five layer coextrusion.

### Structure 2

1. Low density polyethylene (gloss layer) 12 lbs.

2. Paperboard (substrate) 205 lbs.

3. Linear low density polyethylene 5 lbs.

4. Low density polyethylene 2 lbs.

5. Low density polyethylene 4 lbs.

6. Low density polyethylene 4.5 lbs.

7. Tie layer 1.5 lbs.

8. EVOH/LDPE 5 lbs.

9. Tie layer 1.5 lbs.

10. Low density polyethylene 4.5 lbs.

Layers 6-10 are a five layer coextrusion.

### Structure 3

1. Low density polyethylene (gloss layer) 12 lbs.

2. Paperboard (substrate) 205 lbs.

3. Low density polyethylene 11 lbs.

4. Tie layer 1.5 lbs.

5. EVOH/LDPE 3 lbs.

6. Tie layer 1.5 lbs.

7. Low density polyethylene (matte layer) 11 lbs.

Layers 3-7 are a five layer coextrusion.

### Structure 4

1. Low density polyethylene (gloss layer) 12 lbs.

2. Paperboard(substrate) 205 lbs.

3. Low density polyethylene 10 lbs.

4. Tie layer 1.5 lbs.

5. EVOH/LDPE 5 lbs.

6. Tie layer 1.5 lbs.

7. Low density polyethylene 10 lbs.

Layers 3-7 are a five layer coextrusion.

Structures 3 and 4 are embodiments wherein the five layer coextrusion containing the EVOH/LDPE barrier layer is coextrusion coated directly onto the matte side of the paperboard substrate.

### BRIEF DESCRIPTION OF THE DRAWINGS

The invention is further described and depicted in reference to the following drawings wherein:

FIG. 1 is a side cross sectional view of a laminate depicting one of the embodiment of the present invention; and

FIG. 2 is a side cross sectional view of a laminate depicting another embodiment of the present invention.

### DETAILED DESCRIPTION OF THE INVENTION

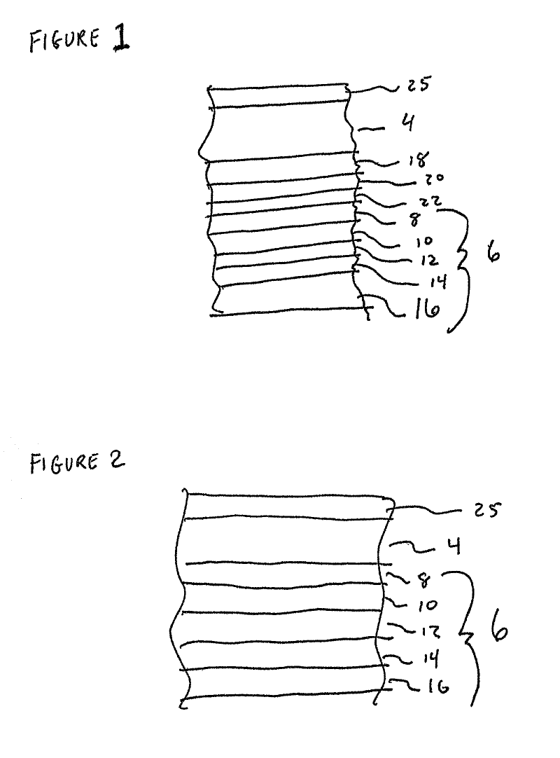

FIG. 1 depicts a preferred embodiment of the invention that is a package for food or non-food products made from a laminate having a paper or paperboard substrate 4. A five layer coextrusion 6 composed of a layer of low density polyethylene 8, a tie layer 10, a composite layer of EVOH/polyolefin 12, a tie layer 14, and a matte layer of low density polyethylene 16, is coextrusion coated onto the substrate 4, through the use of prior applied layers of linear low density polyethylene 18, low density polyethylene 20, and low density polyethylene 22. The substrate 4, such as paper or paperboard, being opaque, can block harmful sunlight or UV radiation which can be detrimental to the contents inside a package.

For various packaging applications, such as liquid packaging, it is sometimes desirable to coat the other side of the substrate 4, with a polyolefin layer 25, such as a layer of polyethylene.

Another embodiment of a packaging structure includes the paper substrate 4, the exterior layer of a polyolefin polymer 8, and the five layer coextrusion composite layer 6, directly extruded onto the substrate 4. (see FIG. 2). The polyolefin layers 16 and 25 serve as the heat sealing layers.

The use of a barrier layer containing the blend (ethylene vinyl alcohol copolymer and low density polyethylene polymer) was tested for efficacy and produced superior results.

Oxygen transmission ratio (OTR) measurements were measured using the following criteria.

### Oxygen Transmission Rate (OTR) Measurements

For OTR measurements, 50 cm² flat samples were cut and placed in an Oxtran 2/20 L module at predetermined temperatures and humidities. Testing was conducted at 5%0, 75%, or 90% relative humidity (RH) and 23° C. or 38° C. The flat board samples were placed in edge effect heads in order to prevent diffusion of oxygen through the edge of the boards. The chamber on one side of the board contained pure oxygen, while the other side was continually flushed with nitrogen. After sufficient time was alloted for boards to equilibrate to the temperature and humidity conditions, the rate of oxygen transmission through the board was recorded by measuring the composition of the carrier gas stream. For high humidity testing (75 and 90%), the boards were place in a tropical chamber to shorten the equilibration time in the module. Data was collected until the composition of the gas stream reached a steady state (20-24 hours).

### EXAMPLE 1

To investigate the effect of blend composition on barrier properties, 5-layer cast films were coextruded incorporating blends with various compositions. The structure of all the films was: 40% LDPE/2% tie/16% Blend/2% tie/40% LDPE. The blends consisted of Soarnol 4412A from Soarus (44 mole % ethylene 12, MI) and 1924P LDPE from Eastman. The films were extruded with a 1″ diameter, single-screw extruder at 230 C. OTR results are shown below.

| | | Total film thickness |
|---|---|---|
| % EVOH in blend (weight) | OTR (cc/m²/atm/day) | (mils) |
| 20 | Too high to measure | 1.5 |
| 25 | Too high to measure | 1.5 |
| 30 | 507 ± 20 | 1.5 |
| 35 | 52 ± 30 | 1.5 |
| 40 | 28 ± 10 | 1.5 |
| 45 | 25 ± 2 | 1.5 |
| 50 | 18 ± 0.3 | 1.5 |
| 60 | 19 ± 2 | 1.4 |
| 70 | 15 ± 0.3 | 1.3 |
| 100 | 10 ± 0.3 | 1.3 |

Further testing was performed with the same structures using 2908D EVOH from Soarus (29 mole % ethylene, 8 MI) instead of 4412A. Results are shown below.

| | | Total film thickness |
|---|---|---|
| % EVOH in blend (weight) | OTR (cc/m²/atm/day) | (mils) |
| 20 | 590 ± 20 | 8 |
| 25 | 580 ± 30 | 8 |
| 30 | 520 ± 5 | 8 |
| 35 | 1.2 ± 0 | 8 |
| 40 | 0.80 ± .3 | 8 |
| 50 | 0.27 ± 0.05 | 8 |
| 70 | 0.069 ± 0.005 | 8 |
| 25 | Too high to measure | 1.5 |
| 30 | Too high to measure | 1.5 |
| 35 | 9.7 ± 0.3 | 1.5 |
| 40 | 3.4 ± 0.8 | 1.5 |
| 50 | 1.2 ± 0 | 1.4 |
| 70 | 0.58 ± 0 | 1.3 |
| 100 | 0.63 ± .03 | 1.3 |

The barrier for the EVOH blends is better than expected based on the OTR values of 100% EVOH and LDPE. The barrier properties correlate with blend morphology. Scanning electron microscopy shown the blends to be composed of two incompatible phases with the discreet component contained in rod or plank like domains in the continuous phase. For compositions with less than 30% EVOH, LDPE is the continuous phase. For composition with greater than 40% EVOH, EVOH is the continuous component. For compositions containing 30-40% EVOH, the phase morphology is cocontinuous, containing localized regions of both EVOH and LDPE continuous phases. The barrier values of the film were close to that of LDPE for the LDPE continuous blends, and close to that of EVOH (within an order of magnitude) for the EVOH continuous blends.

### EXAMPLE 2

The effect of blend composition was investigated in 5-layer structures, coextruded on a pilot line extruder (extrusion coated onto paperboard). The extruder used for the blend layer has a 2.5″ diameter and 28:1 L:D ratio. The melt temperature was 535° F. and the line speed was 450 feet/minute. The structure for all samples was: 12 LDPE/Board/ 4 LDPE/1.5 tie/2 Blend/1.5 tie/4 LDPE The numbers refer to pounds/3000 ft². The OTR was measured at 23° C. and two different humidities. The results are summarized below. OTR is reported in units of cc/m²/day/atm.

| | | | Blend |
|---|---|---|---|
| % EVOH | | | layer |
| (4412A) in | OTR @ 23° C., 0% | OTR @ 23° C., 75% | thickness |
| blend (weight) | RH | RH | (microns) |
| 50 | 49.5 ± 2.7 | 37.3 ± 0.3 | 4.4 |
| 60 | 40.7 ± 18.1 | 19.3 ± 13.3 | 5.1 |
| 70 | 29.1 ± 7.7 | 41.0 ± 10.3 | 5.1 |
| 100 | 15.2 ± 0.4 | 23.0 ± 0.1 | 4.6 |

The barrier effectiveness of the blends increase relative to EVOH as the humidity is increased (At 0% RH, the 50/50 blend has an OTR value 3.25 that of EVOH, but at 75% RH, the factor drops to 1.6). Even at low RH, the OTR value of the 50/50 blend is better than expected based on the values for pure LDPE and EVOH. The aspect ratio of the discreet LDPE domains was found to be about 20:1 with SEM.

### EXAMPLE 3

The effect of morphology on OTR was investigated by comparing OTR values for blends extruded on a cast film extruder (¾ diameter, 25:1 L:D, single-screw extruder) with a couple of different screw configurations and the OTR values for a 5-layer coextruded (extrusion coated onto paperboard) structures prepared on the pilot line described in Example 2. Results are shown below. The cast films and coextruded blends all had a composition of 50/50 EVOH/LDPE (wt/wt). OTR is reported in units of cc*cm/m²/day/atm (corrected for thickness). In order to correct the OTR value for the 5-layer coextruded structure, only the thickness of the blend layer was considered.

| | OTR at | | Aspect ratio |
|---|---|---|---|
| | 23° C., 0% | OTR at 23° C., 75% | of LDPE |
| Sample | RH | RH | domains |
| Cast film, 250° C. | 0.018 ± 0.001 | 0.046 ± 0.001 | 10:1 |
| melt temp, Pin | | | |
| mixing screw | | | |
| Cast film, 250° C. | 0.019 ± 0.001 | 0.048 ± 0.001 | 10:1 |
| melt temp, 3/1 | | | |
| compression ratio | | | |
| screw | | | |
| Cast film, 280° C. | 0.022 ± 0.001 | 0.064 ± 0.002 | 5:1 |
| melt temp, 3/1 | | | |
| compression ratio | | | |
| screw | | | |
| 5-layer coex film | 0.022 ± 0.001 | 0.016 ± 0 | 20:1 |

All 4 structures have similar OTR values at 0% RH when corrected for the barrier layer thickness. At 75% RH, however, the range of OTR values increases. It appears that the lower the aspect ratio of the LDPE domains, the greater the drop in barrier with relative humidity. The aspect ratios resulting from the extrusion coating operation provide the benefit of decreased barrier sensitivity to moisture.

### EXAMPLE 4

Barrier effectiveness at high humidity. The following structures were coextruded with a pilot line extruder (extrusion coated) onto paperboard and tested for barrier effectiveness at 38° C., 90% RH.

12 LDPE/Board/5 LLDPE/2 LDPE/6 LDPE/4.5 LDPE/2 tie/3 barrier/2 tie/4.5 LDPE

The first three layers were coextruded with the first pass, followed by the last 5 layers with a second pass. The numbers refer to pounds/3000 ft². The barrier layers were extruded at 535° F. with a 2.5″ diameter, 28:1 L:D screw. Both passes were extruded at 500 feet/minute. Barrier results are shown below. OTR is reported in units of cc/m²/day/atm.

| Barrier material | OTR @ 38° C., 90% RH |
|---|---|
| EVOH (29 mole % ethylene) | 148.6 ± 0.4 |
| EVOH (44 mole % ethylene) | 157.4 ± 3.4 |
| 50/50 (44 mole % EVOH/LDPE) | 291.4 ± 21.7 |

The OTR of the blend structure is only 1.9 and 2.0 times those of the structure with 100 44 and 29 mole % EVOH, respectively. This result is better than expected based on OTR values for 100% EVOH and LDPE.

### EXAMPLE 5

The following structure was coextruded (extrusion coated onto paperboard) with the same method as the structures in Example 4:

Board/5 LLDPE/2 LDPE/6 LDPE/4.5 LDPE/2 tie/3 barrier/2 tie/4.5 LDPE

Structures were created with various polyolefins in the blend. 44 mole % EVOH was used in all of the structures. The barrier layers were extruded at a melt temperature of 540° F., with a 2.5″, 24:1 L:D screw. Both passes were performed at 500 feet/minute. The results are shown below. OTR is reported in units of cc/m²/day/atm.

| Barrier layer composition | OTR @ 23° C., 50% RH |
|---|---|
| 50/50 EVOH/PP (wt/wt) | 23.0 ± 2.2 |
| 50/50 EVOH/LLDPE (wt/wt) | 16.7 ± 1.3 |
| 50/50 EVOH/LDPE (wt/wt) | 21.2 ± 2.6 |

A variety of polyolefins can be used in the blend composition with similar effectiveness.

### EXAMPLE 6

Additional structures that have been extrusion coated onto board.

Blend extruded at 530-540° F. in 2.5″ diameter, 28:1 L:D screw for the following structures:

12 LDPE

Board

11 LDPE

2 tie

3 Blend (50/50 4412A EVOH/LDPE)

12 tie

11 LDPE

12 LDPE

Board

11 LDPE

2 tie

3 Blend (50/50 2908D EVOH/LDPE)

2 tie

11 LDPE

12 LDPE

BOARD

5 Blend (50/50 4412A EVOH/LDPE)

1.5 Tie

21.5 LDPE

12 LDPE

Board

5 Tie

3 Blend (50/50 4412A EVOH/LDPE)

5 Tie

15 LDPE

The preferred ethylene vinyl alcohol copolymer of the blend layer is an ethylene vinyl alcohol copolymer having an ethylene moiety of 44%. Alternate EVOH materials can have an ethylene content ranging from 29-50%. The polyolefin portion of the blend is low density polyethylene. Alternatively, one can use linear low density polyethylene or polypropylene as the polyolefin portion of the blend. The blend can range from 35-95% EVOH in the blend, preferably 35-70%, with a 50/50 blend being preferred. The weight of the blend layer preferably ranges from 2-10 lbs. per 3,000 square feet. In the five layer coextrusion, the tie layers have weight ranges up to 2.0 lbs. per 3,000 square feet, with the preferred weight being 1.5 lbs. per 3,000 square feet. Any suitable tie material can be used. The outer layers of the five layer coextrusion are layers of low density polyethylene with weights ranging from 4.5-12 lbs. per 3,000 square feet.

The tie layers used in this invention primarily consist of modified polyethylene or modified polypropylene. The modifications are usually chemical grafting or copolymerization with acidic polar function groups such as maleic anhydride, acrylic acid, and methacrylic acid or ester functional groups such as ethyl acrylate and butyl acrylate, etc. Since the amount of polar groups incorporated is usually small, these modified polyolefins maintain their moisture barrier properties. Therefore, one can consider these tie layers as moisture barrier layers as well.

By eliminating the need for a pure layer of EVOH (ethylene vinyl alcohol copolymer) as the oxygen barrier layer in the structure, it can simplify the manufacturing process and significantly lower production costs for some applications.

It is also important that the five layer sandwich be produced by a coextrusion to provide decreased barrier sensitivity to moisture. Example 3 illustrated that the five layer coextrusion exhibited superior barrier Oxygen Transmission Rates to that of structures made by film casting in high moisture environments (75% Relative Humidity).

Other embodiments and variations of the laminate structures contained herein will become apparent to those of ordinary skill in the art upon reading the present disclosure, and it is intended that the present invention be limited only by the broadest interpretation of the appended claims to which the inventor may be legally entitled.

What is claimed is:

1. A laminate for producing a paper package comprising: a paper substrate; and a five layer coextrusion coated onto the substrate, the five layer coextrusion comprising: a first layer of low density polyethylene, a first adhesive tie layer, a blend barrier layer made from ethylene vinyl alcohol copolymer and a polyolefin, a second adhesive tie layer, a second layer of low density polyethylene; wherein the blend barrier layer comprises 35%-95% ethylene vinyl alcohol copolymer.

2. The laminate for producing a paper package in accordance with claim 1, further comprising a polyolefin layer coated onto an uncoated side of the paper substrate.

3. The laminate for producing a paper package in accordance with claim 1, wherein the ethylene vinyl alcohol copolymer has an ethylene content ranging from 29-50%.

4. The laminate for producing a paper package in accordance with claim 1, wherein the ethylene vinyl alcohol copolymer has an ethylene content of 44%.

5. The laminate for producing a paper package in accordance with claim 1, wherein the polyolefin of the blend barrier layer is low density polyethylene, linear low density poly ethylene or polypropylene.

6. The laminate for producing a paper package in accordance with claim 1, wherein the first and second adhesive tie layer is a modified polyethylene or modified polypropylene.

7. The laminate for producing a paper package in accordance with claim 1, wherein the substrate is paperboard.

8. The laminate for producing a paper package in accordance with claim 1, further comprising a layer of linear low density polyethylene and a layer of low density polyethylene applied between the five layer coextrusion and the substrate.

9. The laminate for producing a paper package in accordance with claim 2, wherein the blend barrier layer comprises 50% ethyl vinyl alcohol copolymer with an ethylene content of 44 mole % and 50% low density polyethylene.

10. A package produced from a laminate comprising: a paper substrate; and a five layer coextrusion coated onto the substrate, the five layer coextrusion comprising: a first layer of low density polyethylene, a first adhesive tie layer, a blend barrier layer made from ethylene vinyl alcohol copolymer and a polyolefin, a second adhesive tie layer, a second layer of low density polyethylene; wherein the blend barrier layer comprises 35%-95% ethylene vinyl alcohol copolymer.

11. The package produced from a laminate in accordance with claim 10, further comprising a polyolefin layer coated onto an uncoated side of the paper substrate.

12. The package produced from a laminate in accordance with claim 10, wherein the ethylene vinyl alcohol copolymer has an ethylene content ranging from 29-50%.

13. The package produced from a laminate in accordance with claim 10, wherein the ethylene vinyl alcohol copolymer has an ethylene content of 44%.

14. The package produced from a laminate in accordance with claim 10, wherein the polyolefin of the blend barrier layer is low density polyethylene, linear low density polyethylene or polypropylene.

15. The package produced from a laminate in accordance with claim 10, wherein the first and second adhesive tie layer is a modified polyethylene or modified polypropylene.

16. The package produced from a laminate in accordance with claim 10, wherein the substrate is paperboard.

17. The package produced from a laminate in accordance with claim 10, further comprising a layer of linear low density polyethylene and a layer of low density polyethylene applied between the five layer coextrusion and the substrate.

18. The package produced from a laminate in accordance with claim 11, wherein the blend barrier layer comprises 50% ethyl vinyl alcohol copolymer with an ethylene content of 44 mole % and 50% low density polyethylene.
